(19) United States
(12) Patent Application Publication
(10) Pub. No.: US 2026/0289492 A1
(43) Pub. Date: Sep. 24, 2026

(54) SYSTEM AND METHOD FOR OPTIMIZING RE-ORDERING QUANTITY OF ARTICLES INVENTORY MANAGEMENT

(71) Applicant: Panasonic Intellectual Property Management Co., Ltd., Osaka (JP)

(72) Inventors: RAMDAS KRISHNAKUMAR, Singapore (SG); YUEJINGXIAN MAO, Singapore (SG); MANISH GUPTA, Singapore (SG); PHUNG HUY TO, Ho Chi Minh (VN); DEBDEEP PAUL, Singapore (SG); YUTA SHIMAZAKI, Osaka (JP); CHANDRA SUWANDI WIJAYA, Singapore (SG)

(21) Appl. No.: 19/082,315

(22) Filed: Mar. 18, 2025

(51) Int. Cl. G06Q 10/087

(52) U.S. Cl. CPC G06Q 10/087

(57) ABSTRACT

A method (1000) for optimizing a re-ordering quantity (ROQ) of an article for managing an inventory. The method (1000) includes predicting (1002) a first demand quantity of the article for a first period using a selected artificial intelligence (AI) model from a plurality of models. Further, determining (1004) an error associated with mismanagement of the inventory in a second period. Further, determining (1006) the ROQ for a current period of managing the inventory based on the predicted first demand quantity and the error associated with mismanagement of the inventory. Further, optimizing (1008) the determined ROQ based on a first correction term associated with the current period. The first correction term associated with the current period is determined during the first period.

### FIELD OF THE INVENTION

The present invention generally relates to inventory management, and more particularly relates to a forecast-based optimized spare-part inventory management.

### BACKGROUND

Inventory management has been a vital part of maintaining stock of spare parts, especially, in manufacturing sectors. An unlikely deviation in demand and supply of spare parts often creates an imbalance in an overall chain of the inventory management resulting either in scarcity of stock or accumulation of dead stock. Therefore, to maintain a balance of the stock supply and demand, restocking and forecasting of the restocking becomes significant. Also, maintaining a stable inventory becomes important in the sales of products. For example, if the inventory is surplus, storage costs increase, and conversely, if the inventory becomes scarce, there is a possibility of missing sales opportunities.

In the current inventory management systems, there are two major hurdles involved in maintaining an optimum stock count. A first hurdle is shortage which occurs when a total count of the items in the inventory is less than the demand and therefore, the shortage leads to scarcity of parts or not enough parts to meet the requirement. The shortage leads to lost revenue or machine stoppage. A second hurdle is the dead stock which occurs when the total count of items in inventory is much more than demand, leading to a surplus of parts or a lot of stock stuck in the inventory without being utilized. The dead stock leads to capital tied up in unused parts and increased storage costs.

Therefore, in view of the above-mentioned problems, it is advantageous to provide an improved system and method that can overcome the above-mentioned problems and limitations associated with the existing techniques by dynamic optimization of re-order quantity for smart inventory management.

### SUMMARY

This summary is provided to introduce a selection of concepts, in a simplified format, that are further described in the detailed description of the invention. This summary is neither intended to identify key or essential inventive concepts of the invention nor is it intended for determining the scope of the invention.

According to one embodiment of the present disclosure, a method for optimizing a re-ordering quantity (ROQ) of an article for managing an inventory is disclosed. The method includes predicting a first demand quantity of the article for a first period using a selected artificial intelligence (AI) model from a plurality of predictive models, such as, machine learning (ML) model, Deep Learning model. Further, the method includes determining an error associated with mismanagement of the inventory in a second period. Further, the method includes determining the ROQ for a current period of managing the inventory based on the predicted first demand quantity and the error associated with mismanagement of the inventory. The method further includes optimizing the determined ROQ based on a first correction term associated with the current period. The first correction term associated with the current period is determined during the first period.

According to one embodiment of the present disclosure, a method for optimizing a re-ordering quantity (ROQ) of an article for managing an inventory is disclosed. The method includes predicting a first demand quantity of the article for a subsequent period of managing the inventory using a selected artificial intelligence (AI) model from a plurality of predictive models, such as, machine learning (ML) model, Deep Learning model. The method further includes determining an error associated with the mismanagement of the inventory in a previous period of managing the inventory. Further, the method includes determining the ROQ for a current period of managing the inventory based on the predicted first demand quantity and the error associated with the mismanagement of the inventory. Furthermore, the method includes optimizing the determined ROQ based on a first correction term associated with the current period. The first correction term associated with the current period is determined during the previous period.

According to one embodiment of the present disclosure, a system for optimizing a re-ordering quantity (ROQ) of an article for managing an inventory is disclosed. The system includes a memory, and a processor communicatively coupled with the memory. The processor is configured to predict a first demand quantity of the article for a first period using a selected artificial intelligence (AI) model from a plurality of predictive models, such as, machine learning (ML) model, Deep Learning model. Further, the processor is configured to determine an error associated with the mismanagement of the inventory in a second period. Further, the processor is configured to determine the ROQ for a current period of managing the inventory based on the predicted first demand quantity and the error associated with the mismanagement of the inventory. Further, the processor is configured to optimize the determined ROQ based on a first correction term associated with the current period. The first correction term associated with the current period is determined during the first period.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a schematic block diagram depicting an environment for the implementation of a system for optimizing a re-ordering quantity (ROQ) of an article for managing an inventory, according to an embodiment of the present invention;

FIG. 2 illustrates a schematic block diagram of modules of the system for optimizing the ROQ of the article for managing the inventory, according to an embodiment of the present invention;

FIGS. 3A-3C illustrate exemplary charts depicting inventory graphs for stable, shortage, and surplus inventory, according to an embodiment of the present invention;

FIG. 4 illustrates an exemplary flowchart depicting a detailed workflow of the system, according to an embodiment of the present invention;

FIG. 5 illustrates a schematic depicting an architecture of the system, according to an embodiment of the present invention;

FIG. 6 illustrates a schematic depicting ROQ calculation of reorder amount based on multiple inputs, according to an embodiment of the present invention;

FIG. 7 illustrates a schematic depicting a prediction timeline for the ROQ of the article, according to an embodiment of the present invention;

FIG. 8 illustrates an exemplary chart depicting an inventory surplus graph corresponding to a feed-forward correction (FCC) term, according to an embodiment of the present invention;

FIGS. 9A-9C illustrate exemplary charts depicting the damping property of the FCC corresponding to variation in the ROQ, according to an embodiment of the present invention; and

FIG. 10 illustrates a flowchart depicting a method for optimizing the ROQ of the article for managing the inventory, according to an embodiment of the present invention.

Further, skilled artisans will appreciate that elements in the drawings are illustrated for simplicity and may not have necessarily been drawn to scale. For example, the flow charts illustrate the method in terms of the most prominent steps involved to help improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION

For the purpose of promoting an understanding of the principles of the invention, reference will now be made to the various embodiments and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect,” “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Due to the evolving landscape of industrial automation demands, there is a need for adaptive systems that may refine the re-ordering quantity by dynamically estimating the requirement for each re-order cycle. By acknowledging the challenges associated with inventory management, there is a requirement for developing robust forecast-based optimized spare-part inventory management.

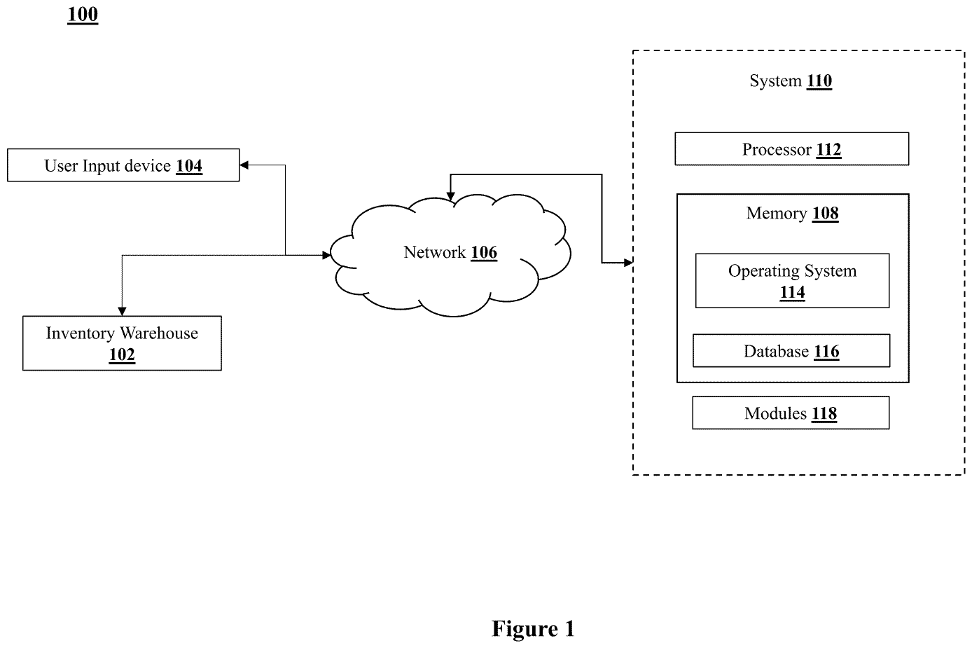

FIG. 1 illustrates a schematic block diagram depicting an environment 100 for the implementation of a system 110 for optimizing a re-ordering quantity (ROQ) of an article for managing an inventory, according to an embodiment of the present invention. For the sake of brevity, the system 110 for optimizing the ROQ of the article for managing the inventory is hereinafter interchangeably referred to as the system 110.

In an embodiment, referring to FIG. 1, the system 110 may be implemented between an inventory warehouse 102 and a user input device 104. In another embodiment, the system 110 may be implemented between the inventory warehouse 102 and the user input device 104 over a network 106. In at least one embodiment, the system 110 may be a part of the user input device 104. The inventory warehouse 102 may correspond to stocks of articles stored in a physical storage area. In an exemplary embodiment, the inventory warehouse 102 may be a manufacturing unit of an article. According to one or more embodiments of the present disclosure, the articles stored in the inventory warehouse 102 may include but are not limited to, spare parts required to manufacture the article at the manufacturing unit. In an embodiment, the inventory warehouse 102 may be referred to as a spare-part inventory warehouse.

Further, in the example, the user input device 104 may correspond to a smart device like, a remote computer, smartphone, etc., configured to generate instructions for transmitting re-order quantity (ROQ) request and receiving information related to the status of inventory. In a non-limiting example, the user input device 104 may be a physical device that may be installed within the inventory warehouse 102 and may be configured to obtain information related to inventory.

The user input device 104 may be in communication with the system 110. The system 110 may be configured to optimize the re-stocking of inventory, reducing overhead costs while maintaining sufficient quantities of stock.

Further, the system 110 may be configured to utilize a bank of predictive models, such as, machine learning (ML) model, Deep Learning model with each model trained for specific purpose based on different parameters. In an embodiment, the bank of predictive models may be used interchangeably with a plurality of ML models or a plurality of predefined AI models or an ML model or an AI model or a model. Each model utilizes historical data related to inventory management and predicts and forecasts requirement of ROQ. The ROQ may be dependent on prediction or predicted value, surplus or shortage from previous order and correction factor. The following paragraphs provide a detailed explanation of the working of the system 110.

The system 110 may include, but is not limited to, at least one processor 112 (alternatively referred to as processor), memory 108. The memory 108 may include an operating system 114 and a database 116. The system 110 may include modules 118. The memory 108 and modules 118 may be communicably coupled to the processor 112.

The processor 112 can be a single processing unit or several units, all of which could include multiple computing units. The processor 112 may be implemented as one or more microprocessors, microcomputers, microcontrollers, digital signal processors, central processing units, state machines, logic circuitries, and/or any devices that manipulate signals based on operational instructions. Among other capabilities, the processor 112 is adapted to fetch and execute computer-readable instructions and data stored in the memory 108.

The memory 108 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

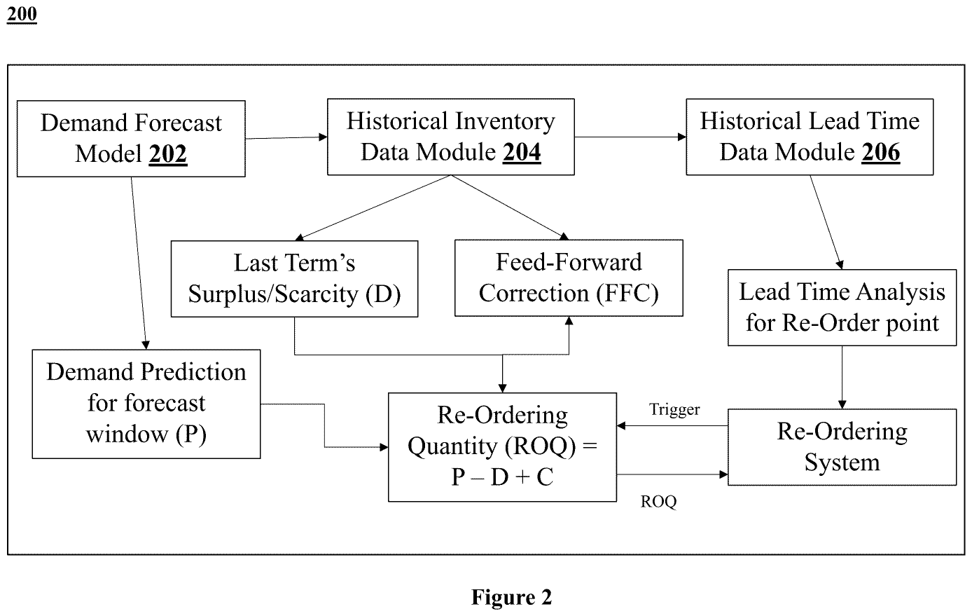

The modules 118 may include a demand forecast model 202, a historical inventory data module 204, a historical lead time data module 206, lead time analysis for re-order point (ROP) module 208. The modules 118 will be described in greater detail in conjunction with FIG. 2. The modules 118, amongst other things, include routines, programs, objects, components, data structures, etc., which perform particular tasks or implement data types. The modules 118 may also be implemented as, signal processor(s), state machine(s), logic circuitries, and/or any other device or component that manipulates signals based on operational instructions.

Further, the modules 118 can be implemented in hardware, instructions executed by a processing unit, or by a combination thereof. The processing unit can comprise a computer, a processor, a state machine, a logic array, or any other suitable devices capable of processing instructions. The processing unit can be a general-purpose processor which executes instructions to cause the general-purpose processor to perform the required tasks or, the processing unit can be dedicated to performing the required functions. In another embodiment of the present disclosure, the modules 118 may be machine-readable instructions (software) which, when executed by a processor/processing unit, perform any of the described functionalities.

The network 106 may include wired networks, wireless networks, Ethernet AVB networks, or combinations thereof. The wireless network may be a cellular telephone network, an 802.11, 802.16, 802.20, 802.1Q, or WiMax network. Further, the network 106 may be a public network, such as the Internet, a private network, such as an intranet, or combinations thereof, and may utilize a variety of networking protocols now available or later developed including, but not limited to, TCP/IP based networking protocols. The user input device 104 may not be limited to operation with any particular standards and protocols. For example, standards for Internet and other packet-switched network transmissions (e.g., TCP/IP, UDP/IP, HTML, and HTTP) may be used.

Referring to FIG. 1, the system 110 having the modules 118 may be implemented through the processor 112. In an embodiment, the processor 112 may be configured to predict a first demand quantity of the article for a first period using a selected artificial intelligence (AI) model from a plurality of models. The first period may be referred to as a period before a current period and a second period may be referred to as a period after the current period. Further, prior to predicting the first demand quantity, the processor 112 may be configured to determine a re-ordering point (ROP) in the current period based on an analysis of historical data associated with a lead time corresponding to the re-stocking of the article. Further, the processor 112 may be configured to select, at the ROP, an AI model from a plurality of predefined AI models based on latest error trend from the bank of predictive models which may include a factor of risk weightage. In this embodiment, the processor 112 may predict the first demand quantity for the article in the subsequent period using the selected AI model.

The AI model may be selected based on risk weightage from the plurality of predefined AI models. The processor 112 in this case, may be configured to determine, for each of the plurality of predefined AI models, a corresponding risk weightage. The corresponding risk weightage of each model may be determined based on a prediction error with respect to the mismanagement of the inventory. Further, the processor 112 may be configured to determine a corresponding penalty associated with a type of mismanagement of the inventory. Therefore, based on the determined corresponding risk weightage, the AI model may be selected. In an embodiment, the type of mismanagement of the inventory corresponds to one of a scarce stocking of the article and a surplus stocking of the article.

According to the above embodiment, a relationship between the corresponding penalty associated with the scarce stocking of the article and the corresponding penalty associated with the surplus stocking of the article is based on a risk appetite associated with the scarcity of the article.

Further, the processor 112 may be configured to determine an error associated with mismanagement of the inventory in a second period. In an embodiment, the processor 112, to determine the error associated with the mismanagement of the inventory, may determine the error based on a difference between a remaining quantity of the article at the end of the previous period and a predefined minimum quantity of the article maintained in the inventory. The predefined minimum quantity maintained in the inventory may be referred to as a safety stock. Further, the processor 112 may be configured to determine the ROQ for a current period of managing the inventory based on the predicted first demand quantity and the error associated with the mismanagement of the inventory.

Further, the processor 112 may be configured to optimize the determined ROQ based on a first correction term associated with the current period. The first correction term associated with the current period is determined during the second period. In an embodiment, the processor 112 may be configured to determine a second correction term associated with the subsequent period based on the error associated with the mismanagement of the inventory in the previous period and the first correction term associated with the current period. In an embodiment, the future correction terms may be calculated recursively from every previous error. The second correction term associated with the subsequent period may be inversely proportional to the determined ROQ for the current period.

FIG. 2 illustrates a schematic 200 block diagram of the modules 118 of the system 110 for optimizing the ROQ of the article for managing the inventory, according to an embodiment of the present invention.

The system 110 may optimize the ROQ of the article for managing the inventory. The ROQ may be calculated based on multiple parameters, including, a demand prediction for a forecast window (P), a last term's surplus or scarcity (D), and a feed-forward correction (FFC) (C). In the illustrated embodiment, the modules 118 of the system 110 may include the demand forecast model 202, the historical inventory data module 204, the historical lead time data module 206, the lead time analysis for re-order point (ROP) module 208.

The demand forecast model 202 may be configured to generate the demand prediction for the forecast window (P). The system 110 may retrieve the last term's surplus/scarcity (D) and the FFC (C) from the historical inventory data module 204. Further, the lead time analysis for ROP may be retrieved from the historical lead time data module 206. Further, the ROQ may be triggered when the ROQ is above a predetermined threshold. The system 110 may optimize the re-stocking of inventory, reducing overhead costs while maintaining enough stock. In an embodiment, the lead time analysis for re-order point (ROP) module 208 may be configured to provide the ROP of the inventory at the start of the lead time. The ROP may be a start point of the lead time and may ensure that the stock is order exactly right time and there may be sufficient stock left for the rest of the term/period/month.

The system 110 may update the FFC term based on the current correction term and feed-forward to the next window. The ROQ may be triggered at the start of the lead time, followed by the prediction window.

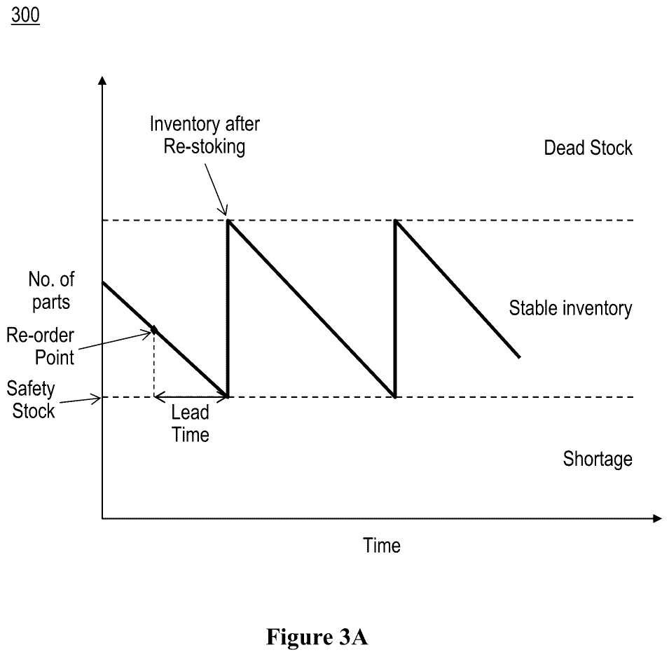

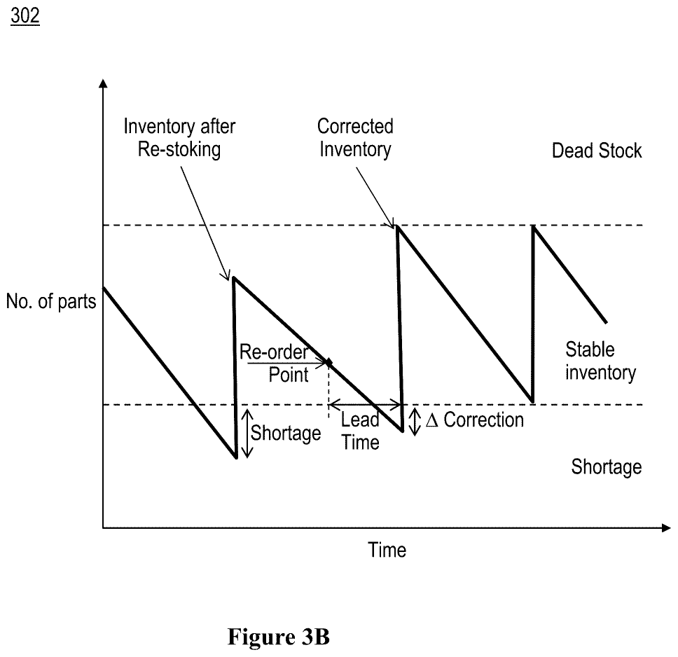

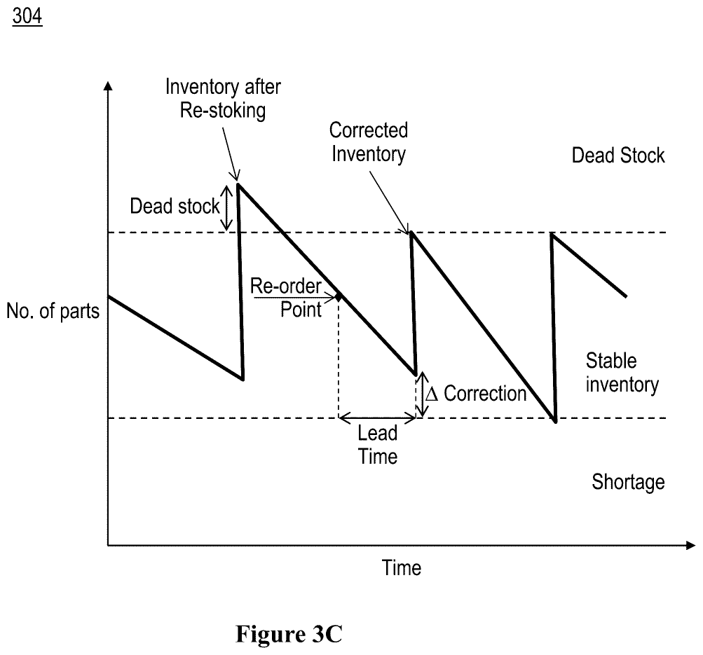

FIGS. 3A-3C illustrate exemplary charts depicting inventory graphs for stable inventory graph 300, shortage inventory graph 302, and surplus inventory graph 304 inventory, according to an embodiment of the present invention.

The charts illustrate different parameters for a total number of stocks over time to keep the inventory on a stable curve between shortage and dead stock/surplus stock. The different parameters include a re-order point (ROP), a lead time, safety stock, a shortage, and a surplus. The (ROP) may be defined as a date or time for placing the order. The ROP may be triggered when the inventory forecast predicted by the AI model indicates that the stock left may be sufficient till the re-stocking time or time of arrival of the re-ordered stock. The ROP may be an initial point for the lead time.

The lead time may be defined as a time taken from the ROP to a point where the order may be received. In an embodiment, the lead time may indicate a metric from a vendor. The lead time may ensure that the stock left within the inventory may be stable till the order is received. The stable may indicate that the demand/supply may be efficiently met. The safety stock may be defined as the stock or minimum inventory to be maintained to ensure normal working.

The shortage or shortage of stock may occur when a predicted value may be less than an actual demand. This may be referred to as an under-predicting. During the shortage, the inventory may dip below the safety stock leading to scarcity. The surplus may occur when the predicted value may be more than the actual demand. This may be referred to as over-predicting. During the surplus, a lot of dead stock may be accumulated.

The stable inventory graph 300 may state that the inventory may be stable when the ROP may be triggered with the sufficient stock till the arrival of the order. In an exemplary embodiment, the ROP may be triggered considering the ROQ calculated. As mentioned earlier, the ROQ may be dependent on the demand prediction for the forecast window (P), the last term's surplus or scarcity (D), and a feed-forward correction (FFC) (C), calculated from the following equation (1):

$$R O Q = P - D + C \qquad ( 1 )$$

The shortage inventory graph 302 may illustrate a shortage of inventory. The ROP may be triggered with less safety stock left and the lead time. Therefore, the corrected inventory may be done by calculating a difference between the FFC (C) or correction and the shortage/scarcity in the previous inventory (D). In this case, the corrected inventory may be done by adding the correction.

The surplus inventory graph 304 may illustrate the surplus of the inventory. The ROP may be triggered with more than the required safety left and the lead time. Therefore, the corrected inventory may be done by calculating a difference between the FFC (C) or correction and the surplus in the previous inventory (D). In this case, the corrected inventory may be done by removing the correction.

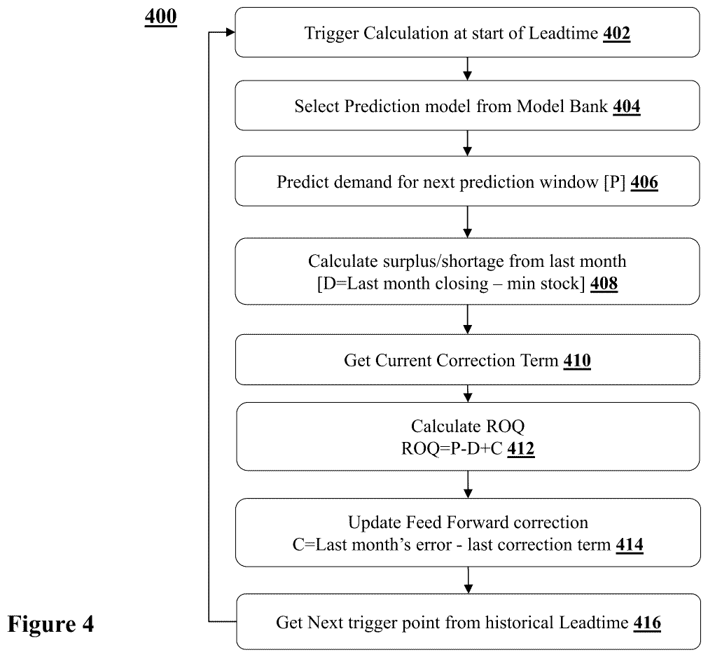

FIG. 4 illustrates an exemplary flowchart 400 depicting a detailed workflow of the system 110, according to an embodiment of the present invention.

At operation 402, the system 110 may trigger the calculation of the inventory at the start of the lead time. In an embodiment, the calculation of the inventory, for example, for a specific spare part/article, may be triggered at the start of the lead time. In an exemplary embodiment, the lead time may determine a specific time when an order needs to be placed. For example, the lead time is 5 days and if the order is needed on the 30^{th} of a month, then the actual order needs to be placed on the 25^{th} of that month.

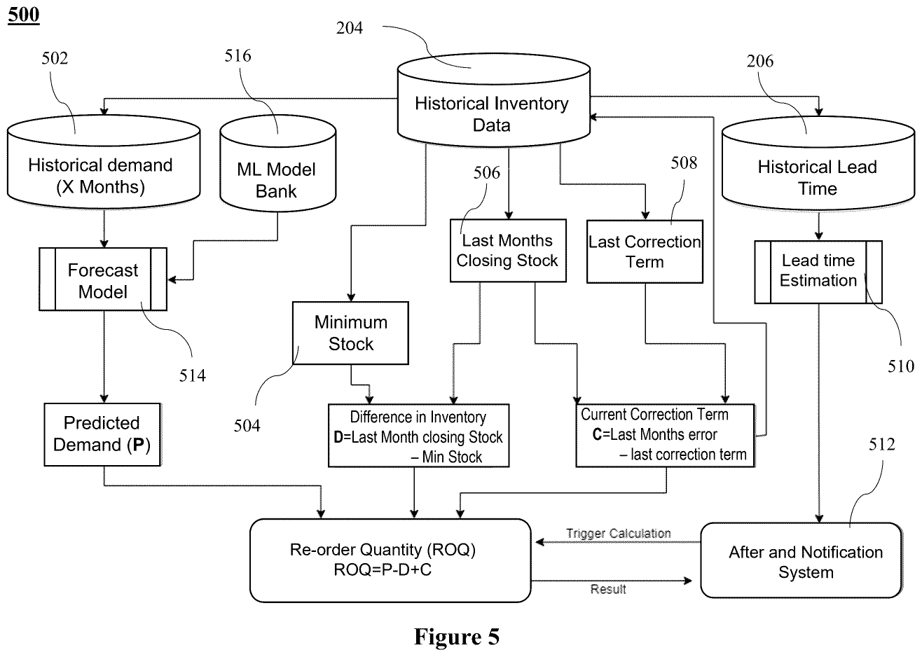

At operation 404, the system 110 may select a prediction model from a model bank, as illustrated in an architecture of the system 110 in FIG. 5. The model bank may include the plurality of AI models or prediction models. For the sake of brevity, the prediction model, plurality of AI models or AI model, model, or the plurality of ML models or ML model may be used interchangeably throughout the detailed description. Also, for brevity, the inventory, the inventory stock, or stock may be used interchangeably.

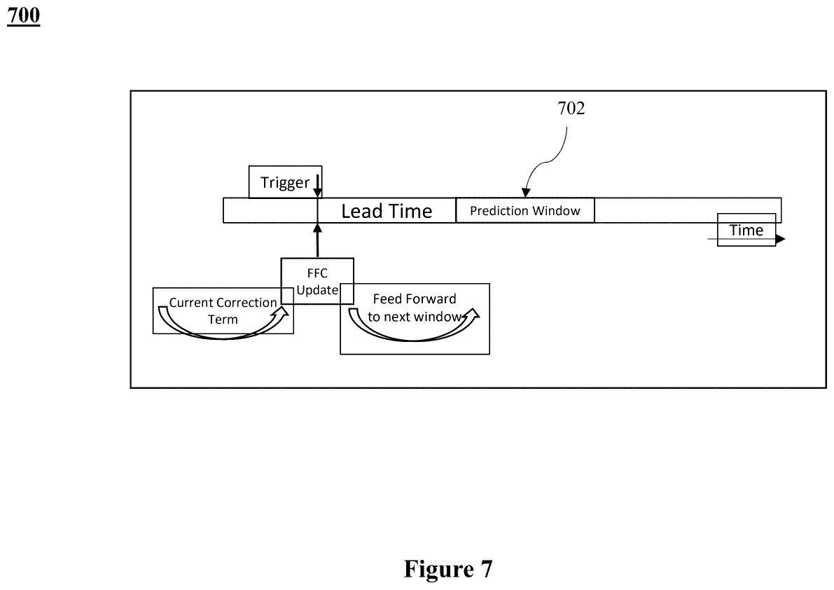

The prediction model may be fed with the historical data related to the ROQ and demand data for the stable inventory. The prediction model may predict a quantity of inventory that may be required for a prediction window 702, as illustrated in FIG. 7. The prediction window may be a month, a quarter, a year, etc. In an embodiment, the prediction window may be based on the lead time and cost associated with the product/spare part. For example, if the spare part is expensive, the delivery charges may be considered by the prediction model to generate the prediction window.

At operation 406, the system 110 may predict demand for the next prediction window (P). The system 110 may predict demand of the inventory for subsequent windows or the next prediction window (P). The next prediction window (P) may be referred to as the ROQ that may be calculated considering the surplus or the shortage of the previous term.

At operation 408, the system 110 may calculate the surplus or the shortage for last term (D=last month closing−minimum stock). D may be calculated by subtracting the last month closing from the safety stock or the minimum stock. In one case, when the last month's closing is around the safety stock, then the surplus or the shortage may be nearly zero. In another case, when the last month's closing is less than the safety stock, then the surplus or the shortage may be negative. Stated differently, there may be shortage of the inventory. In another case, when the last month's closing is more than the safety stock, then the surplus or the shortage may be positive. Stated differently, there may be surplus of the inventory.

At operation 410, the system 110 may get current correction term. In an embodiment, the current correction term may be referred to a correction value that may be added to account for any cascading error of the system 110 from previous predictions. The correction term may be referred to as the FFC. The FFC may be updated and fed to the prediction model for the next month/period prediction. In an embodiment, the current correct term may be updated for the FFC of the next month prediction.

At operation 412, the system 110 may calculate the ROQ. As mentioned in the equation (1) earlier, the ROQ may be calculated from the prediction window (P) or predicted quantity of the inventory minus the surplus/shortage of the last term (D) and adding the FFC (C). In one example, referring to FIG. 3A, there is no shortage or the D is zero, the inventory value is approximately equal to the safety stock, and then

$$R O Q = P + C ; D = 0 , P = 10 , and C = 1 \\ R O Q = 10 + 1 = 11 .$$

In another example, referring to FIG. 3B, there is the shortage, the ROQ may include prediction (P) for the next month plus the correction (C) to account for the introduction of the shortage. In this case,

$$R O Q = P - ( - D ) + C = P + D + C ; P = 10 , \\ Shortage ( D ) = Current inventory value - Safety stock = 23 = - 1 , C = 1 \\ R O Q = 10 - ( - 1 ) + 1 = 12$$

Therefore, the correction term may increase the amount of error code. Stated differently, the ROQ may be higher to account for the shortage in the next month.

In another example, referring to FIG. 3C, there is the surplus, the ROQ may be prediction (P) for the next month minus the correction (C) to account the surplus. In this case,

$$R O Q = P - D + C ; P = 10 , \\ Surplus ( D ) = Safety stock - Current inventory value = 43 = 1 , C = 1 \\ R O Q = 10 - 1 + 1 = 10 .$$

At operation 414, the system 110 may update the FFC (C)=last month's error-last correction term. In an embodiment, the FFC may be updated for the next month to feed the correction forward. The last month's error may be the shortage or surplus. The FFC will be described further in conjunction with FIGS. 5-9C.

At operation 416, the system 110 may get next trigger point from historical lead time. In an embodiment, the next trigger point may be a next lead time for the next month/term.

FIG. 5 illustrates a schematic depicting an architecture 500 of the system 110, according to an embodiment of the present invention.

The system 110 may include the historical inventory data module 204 and the historical lead time data module 206 and a historical demand (X months) 502. The historical inventory data module 204 may be configured to store minimum stock 504, last months' closing stock 506, and a last correction term 508. The minimum stock 504 and the last months' closing stock 506 may be utilized for calculating difference in inventory, i.e., the shortage or the surplus (D) which is equal to difference between the last month's closing stock 506 and the minimum stock 504. Further, the last correction term 508 and the last month's closing stock 506 may be utilized for calculating current correction term or correction (C) which is equal to last month's error or closing 506 minus the last correction term 508.

The historical lead time data module 206 may be configured to store lead time estimation 510. The lead time estimation 510 may be utilized for alert and notification system 512 to trigger calculation of the ROQ.

The historical demand 502 may be configured to store a forecast model 514 and a ML model bank 516. The ML model bank 516 may store the plurality of ML models. The forecast model 514 may be selected from the ML model bank 516 to generate a predicted demand (P). The predicted demand (P), the difference in the inventory (D), the current correction term (C) may be utilized to generate the ROQ. The result from the ROQ may share the ROQ with the alert and notification system 512.

In an embodiment, in conjunction with operation 404, X number of models may be used to predict the value in next prediction window. The models may be ranked based on last prediction's error subjected to a penalty term, which can be tweaked as required. The penalty term may be set based on the risk appetite of the outcome.

For example, the risk from shortage is much higher than risk from surplus. Therefore, the penalty for error from shortage is greater than surplus. The risk weightage may be calculated from the following equation (2) and the selected model may be a model with least risk weightage, as shown in equation (3).

$$Risk {Weightage}_{x} = Prediction {Error}_{x - 1} \times {Penality}_{x} \qquad ( 2 )$$

$$Selected model = Least ( Risk Weightage ) \qquad ( 3 )$$

Table 1 illustrates the plurality of ML models along with error, the shortage/surplus, the penalty term, and the risk weightage. For example, a penalty term of 1 may be for the surplus and 1.5 for the shortage, as the shortage may be worse than the surplus.

TABLE 1

| | | Shortage/ | | Risk |
|---|---|---|---|---|
| Model | Error | Surplus | Penalty | Weightage |
| 1 | 10 | Shortage | 1.5 | 15 |
| 2 | 5 | Shortage | 1.5 | 7.5 |
| 3 | 6 | Surplus | 1 | 6 |
| 4 | 10 | Surplus | 1 | 10 |
| 5 | 7 | Surplus | 1 | 7 |
| 6 | 6 | Shortage | 1.5 | 9 |
| 7 | 8 | Surplus | 1 | 8 |
| 8 | 5 | Shortage | 1.5 | 7.5 |

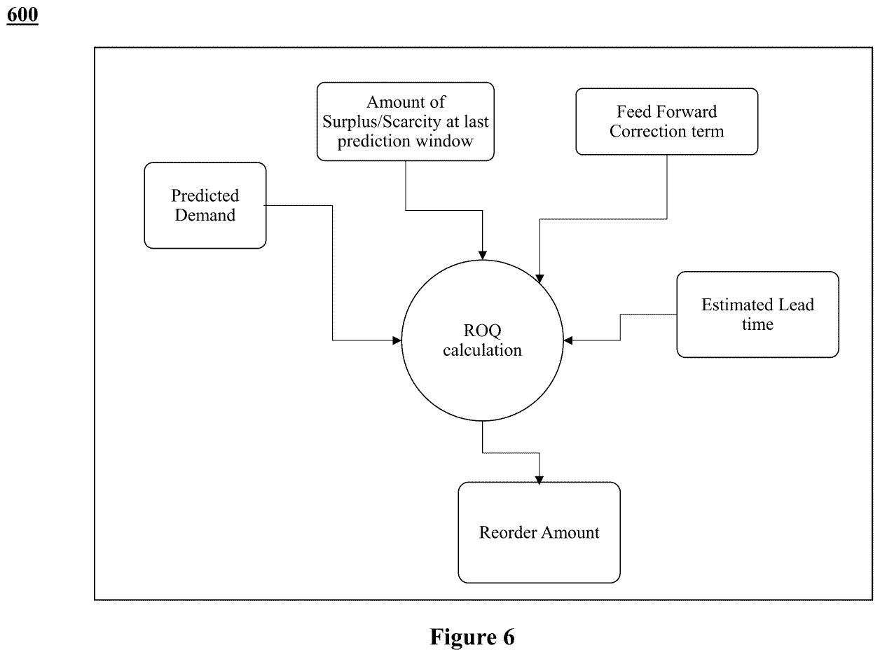

FIG. 6 illustrates a schematic 600 depicting ROQ calculation of reorder amount based on one or more parameters, according to an embodiment of the present invention.

The system 110 may, by the AI model, generate the ROQ by considering one or more parameters. The one or more parameters may include a predicted demand for the inventory as generated by the prediction model. Amount of surplus or shortage of the last prediction window, as explained earlier. The feed-forward correction (FFC) term and the lead time are estimated. Based on the one or more parameters fed into the AI model, a re-order amount may be generated.

FIG. 7 illustrates a schematic 700 depicting a prediction timeline for the ROQ of the inventory, according to an embodiment of the present invention.

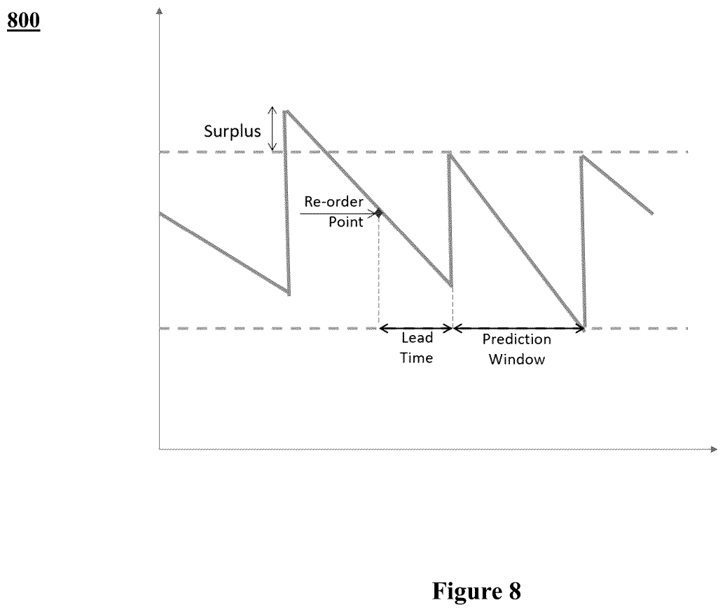

The ROQ may be triggered after the FFC has been updated with the current correction term, such that the FFC may be fed forward to the next window. At the start of the lead time, the ROQ may be triggered considering the prediction window 702. For example, referring to FIG. 8, which illustrates an exemplary chart 800 depicting an inventory surplus graph corresponding to the FFC, the ROP may be a point when the surplus of the previous term/month is reduced or the correction may be negated from the ROQ. The prediction window may consider the correction and the surplus of the previous month to stabilize the chart 800 between the shortage and the surplus.

The FFC may be calculated from the following equation (3):

$$F F {C}_{x} = {Error ( D )}_{x} - F F {C}_{x - 1} \qquad ( 3 )$$

In an embodiment, the FFC may be used to purge any error propagation by proving a forward propagating correction term as a function of realised errors (i.e., end of month surplus/shortage) from previous months. In one example, when the prediction model has over-predicted historically, the current P-D value may be very small as D may be very large. The larger C term may push the ROQ a bit higher muting a large swing. In another example, when the prediction model has under-predicted historically, the current P-D value may be very large as D may be very small or even negative. The smaller or negative C value may stop the system 110 from placing a too high value of the ROQ. In an embodiment, the FFC may act as a damper to prevent the equation (2) from over correcting.

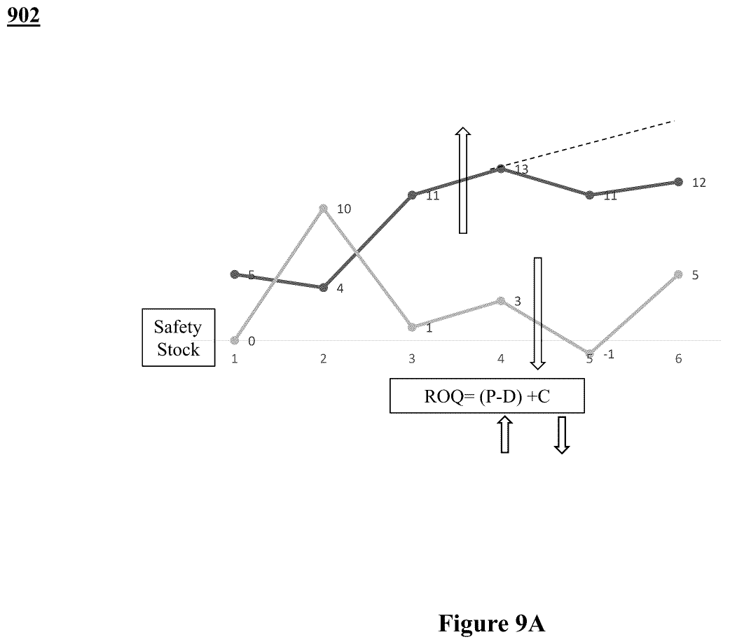

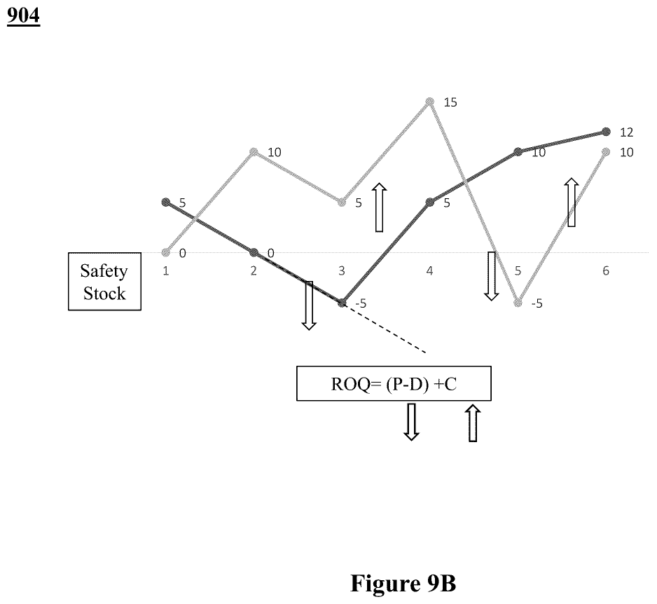

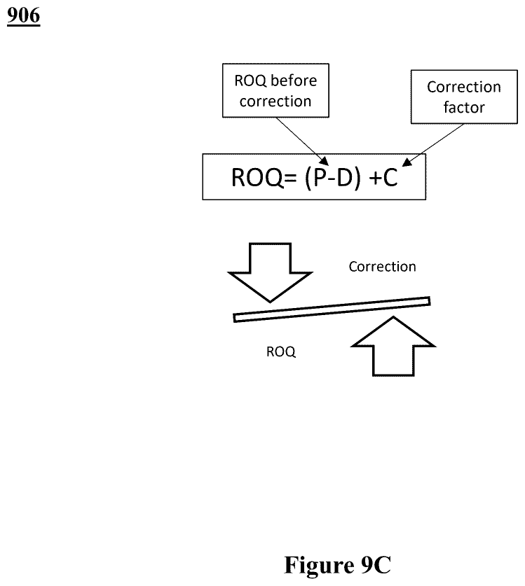

FIGS. 9A-9C illustrate exemplary charts depicting damping property of the FCC corresponding to variation in the ROQ, according to an embodiment of the present invention.

In an embodiment, the damping factor may be utilized to consider variability in demand and lead time and buffering against uncertainty. The damping factor may introduce a safety margin or buffer to account for variability and uncertainty. The damping factor may adjust the reorder quantity to ensure a more robust stock level that may handle fluctuations in demand and lead time without leading to frequent stockouts or excessive inventory holding costs.

As illustrated in FIG. 9A, the chart 902 depicts the ROQ with correction with respect to the correction. The chart 902 may depict the surplus error propagated.

In one example, when the prediction (P) and the surplus or shortage (D) may increase, the correction may decrease. In other words, the ROQ may be inversely proportional to the correction, as illustrated by a schematic 906, in FIG. 9C. The term “P-D” may be referred to as the ROQ before correction and “C” in this case may be the correction factor or correction term or correction. As illustrated, the ROQ, at point 13 may follow a linear trajectory, however, as the correction value is introduced, the ROQ may be stabilized.

As illustrated in FIG. 9B, the chart 904 depicts the scarcity error propagated. In this case, the prediction (P) and the shortage (D) may be decreasing and the correction (C) may increase. For instance, the ROQ may follow a linear trajectory from point 2 to point −5, however, as the correction value is introduced, the ROQ may be stabilized.

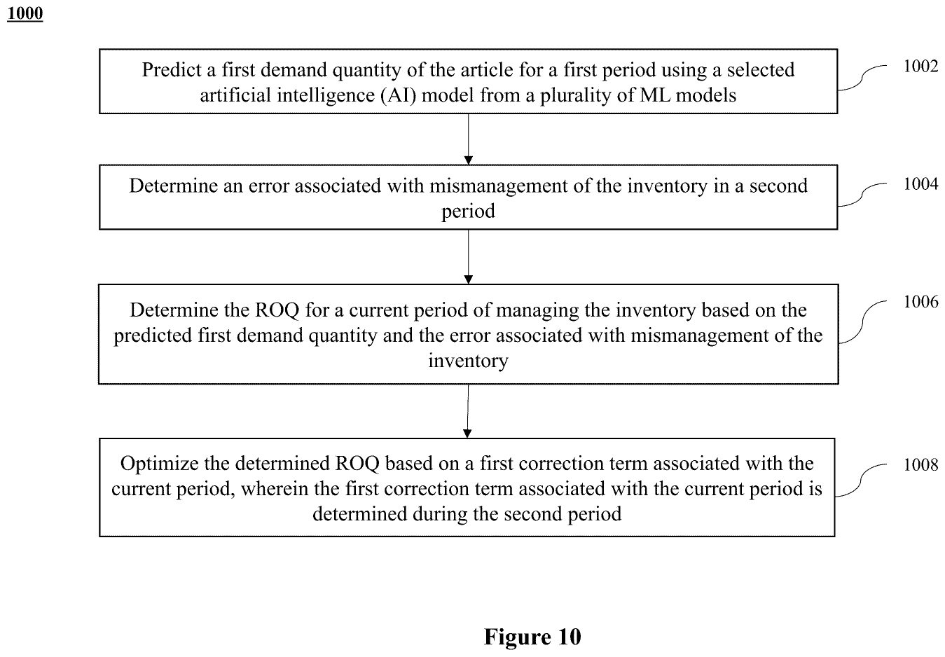

FIG. 10 illustrates a flowchart depicting a method 1000 for optimizing the ROQ for managing the inventory, according to an embodiment of the present invention.

The method 800 may be a computer-implemented method executed, for example, by the processor 112 and the modules 118. For the sake of brevity, constructional and operational features of the system 110 that are already explained in the description of FIG. 1, FIG. 2, FIG. 3A-3C, FIG. 4, FIG. 5, FIG. 6, FIG. 7, FIG. 8, and FIGS. 9A-9C are not explained in detail in the description of FIG. 8.

At operation 1002, the method 1000 may include predicting the first demand quantity of the article for the first period using a selected artificial intelligence (AI) model from a plurality of ML models. The first period is before the current period.

At operation 1004, the method 1000 may include determining an error associated with mismanagement of the inventory in the second period. The second period is after the current period.

At operation 1006, the method 1000 may include determining the ROQ for the current period of managing the inventory based on the predicted first demand quantity and the error associated with mismanagement of the inventory.

At operation 1008, the method 1000 may include optimizing the determined ROQ based on a first correction term associated with the current period. The first correction term associated with the current period is determined during the first period.

While the above discussed steps in FIGS. 4 and 10 are shown and described in a particular sequence, the steps may occur in variations to the sequence in accordance with various embodiments. Further, a detailed description related to the various steps of FIG. 10 is already covered in the description related to FIGS. 1-9C and is omitted herein for the sake of brevity.

The present invention provides various advantages:
The present invention facilitates the stabilization of demand and supply of inventory by predicting re-ordering points and ensuring a smooth supply of spare parts till the order is received.
The present invention provides a feed-forward correction term that limits any prediction error from propagating by culling any accumulated errors from previous model predictions at each iteration.
The present invention considers existing surplus and the accumulation of prediction error as well as overall risk appetite for shortage, when calculating the ROQ.
The present invention redefines the ROP based on the part lead time such that the re-stocking happens periodically rather than ad hoc.
The present invention facilitates the stabilization of inventory by removing surplus stock which piles up shelves and capital tied up that may otherwise be put to a better use. Also, the present invention removes the scarcity of stock which generally leads to profit loss or production stop. The present invention refines the re-ordering quantity by dynamically estimating the requirement for each re-order cycle.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

We claim:

1. A method for optimizing a re-ordering quantity (ROQ) of an article for managing an inventory, the method comprising:
predicting a first demand quantity of the article for a first period using a selected artificial intelligence (AI) model from a plurality of machine learning (ML) models;
determining an error associated with mismanagement of the inventory in a second period;
determining the ROQ for a current period of managing the inventory based on the predicted first demand quantity and the error associated with mismanagement of the inventory; and
optimizing the determined ROQ based on a first correction term associated with the current period, wherein the first correction term associated with the current period is determined during the first period.

2. The method as claimed in claim 1, wherein the first period is before the current period and the second period is after the current period.

3. The method as claimed in claim 1, wherein prior to predicting the first demand quantity, the method comprises:
determining a re-ordering point (ROP) in the current period based on an analysis of historical data associated with a lead time corresponding to re-stocking of the article;
selecting, at the ROP, an AI model from a plurality of predefined AI models based on a corresponding risk weightage; and
predicting the first demand quantity for the article in the subsequent period using the selected AI model.

4. The method as claimed in claim 3, wherein selecting the AI model from the plurality of predefined ML models comprises:
determining, for each of the plurality of predefined AI models, a corresponding risk weightage based on a prediction error with respect to the mismanagement of the inventory and a corresponding penalty associated with a type of mismanagement of the inventory; and
selecting the AI model having the least error which considers risk weightage for each type of error from each of the plurality of predefined AI models.

5. The method as claimed in claim 4, wherein the type of mismanagement of the inventory corresponds to one of a scarce stocking of the article, and a surplus stocking of the article.

6. The method as claimed in claim 5, wherein a relationship between the corresponding penalty associated with the scarce stocking of the article and the corresponding penalty associated with the surplus stocking of the article is based on a risk appetite associated with scarcity of the article.

7. The method as claimed in claim 1, wherein determining the error associated with the mismanagement of the inventory comprises:
determining the error based on a difference between a remaining quantity of the article at the end of the previous period and a predefined minimum quantity of the article maintained in the inventory.

8. The method as claimed in claim 1, further comprising:
determining a second correction term associated with the subsequent period based on the error associated with mismanagement of the inventory in the previous period and the first correction term associated with the current period.

9. The method as claimed in claim 8, wherein the second correction term associated with the subsequent period is inversely proportional to the determined ROQ for the current period.

10. A method for optimizing a re-ordering quantity (ROQ) of an article for managing an inventory, the method comprising:
predicting a first demand quantity of the article for a subsequent period of managing the inventory using a selected artificial intelligence (AI) model from a plurality of models;
determining an error associated with mismanagement of the inventory in a previous period of managing the inventory;
determining the ROQ for a current period of managing the inventory based on the predicted first demand quantity and the error associated with mismanagement of the inventory; and
optimizing the determined ROQ based on a first correction term associated with the current period, wherein the first correction term associated with the current period is determined during the previous period.

11. The method as claimed in claim 10, wherein prior to predicting the first demand quantity, the method comprises:
determining a re-ordering point (ROP) in the current period based on an analysis of historical data associated with a lead time corresponding to re-stocking of the article;
selecting, at the ROP, an AI model from a plurality of predefined AI models based on a corresponding risk weightage; and
predicting the first demand quantity for the article in the subsequent period using the selected AI model.

12. The method as claimed in claim 11, wherein selecting the AI model from the plurality of predefined models comprises:
determining, for each of the plurality of predefined AI models, a corresponding risk weightage based on a prediction error with respect to the mismanagement of the inventory and a corresponding penalty associated with a type of mismanagement of the inventory; and
selecting the AI model having the least error which considers risk weightage for each type of error from each of the plurality of predefined AI models.

13. The method as claimed in claim 12, wherein the type of mismanagement of the inventory corresponds to one of a scarce stocking of the article, and a surplus stocking of the article.

14. The method as claimed in claim 13, wherein a relationship between the corresponding penalty associated with the scarce stocking of the article and the corresponding penalty associated with the surplus stocking of the article is based on a risk appetite associated with scarcity of the article.

15. The method as claimed in claim 10, wherein determining the error associated with the mismanagement of the inventory comprises:
determining the error based on a difference between a remaining quantity of the article at the end of the previous period and a predefined minimum quantity of the article maintained in the inventory.

16. The method as claimed in claim 10, further comprising:
determining a second correction term associated with the subsequent period based on the error associated with mismanagement of the inventory in the previous period and the first correction term associated with the current period.

17. The method as claimed in claim 16, wherein the second correction term associated with the subsequent period is inversely proportional to the determined ROQ for the current period.

18. A system for optimizing a re-ordering quantity (ROQ) of an article for managing an inventory, the system comprising:
a memory;
a processor communicatively coupled to the memory, the processor is configured to:
predict a first demand quantity of the article for a first period using a selected artificial intelligence (AI) model from a plurality of models;
determine an error associated with mismanagement of the inventory in a second period;
determine the ROQ for a current period of managing the inventory based on the predicted first demand quantity and the error associated with mismanagement of the inventory; and
optimize the determined ROQ based on a first correction term associated with the current period, wherein the first correction term associated with the current period is determined during the second period.

19. The system as claimed in claim 18, wherein the first period is before the current period and the second period is after the current period.

20. The system as claimed in claim 18, wherein prior to predicting the first demand quantity, the processor is configured to:
determine a re-ordering point (ROP) in the current period based on an analysis of historical data associated with a lead time corresponding to re-stocking of the article;
select, at the ROP, an AI model from a plurality of predefined AI models based on a corresponding risk weightage; and
predict the first demand quantity for the article in the subsequent period using the selected AI model.

21. The system as claimed in claim 20, wherein the processor, to select the AI model from the plurality of predefined models, is configured to:
determine, for each of the plurality of predefined AI models, a corresponding risk weightage based on a prediction error with respect to the mismanagement of the inventory and a corresponding penalty associated with a type of mismanagement of the inventory; and
select the AI model having the least corresponding risk weightage from the plurality of predefined AI models.

22. The system as claimed in claim 20, wherein the type of mismanagement of the inventory corresponds to one of a scarce stocking of the article, and a surplus stocking of the article.

23. The system as claimed in claim 22, wherein a relationship between the corresponding penalty associated with the scarce stocking of the article and the corresponding penalty associated with the surplus stocking of the article is based on a risk appetite associated with scarcity of the article.

24. The system as claimed in claim 18, wherein the processor to determine the error associated with the mismanagement of the inventory, is configured to:
determine the error based on a difference between a remaining quantity of the article at the end of the previous period and a predefined minimum quantity of the article maintained in the inventory.

25. The system as claimed in claim 18, wherein the processor is configured to:
determine a second correction term associated with the subsequent period based on the error associated with mismanagement of the inventory in the previous period and the first correction term associated with the current period.

26. The system as claimed in claim 25, wherein the second correction term associated with the subsequent period is inversely proportional to the determined ROQ for the current period.
